(19) United States
(12) Patent Application Publication
(10) Pub. No.: US 2010/0201039 A1
(43) Pub. Date: Aug. 12, 2010

(54) METHOD OF PREPARING A FLEXOGRAPHIC PRINTING FORME

(75) Inventors: Luc Leenders, Herentals (BE); Eddie Daems, Herentals (BE)

Correspondence Address: AGFA;c/o KEATING & BENNETT, LLP, 1800 Alexander Bell Drive, SUITE 200, Reston, VA, 20191, US

(73) Assignee: AGFA GRAPHICS NV, Mortsel (BE)

(21) Appl. No.: 12/675,996

(22) PCT Filed: Aug. 25, 2008
(86) PCT No.: PCT/EP08/61065

§ 371 Date: Mar. 2, 2010

Related U.S. Application Data
(60) Provisional application No. 60/971,670, filed on Sep. 12, 2007.

(30) Foreign Application Priority Data
Sep. 10, 2007 (EP) 07116003.0

(51) Int. Cl. B29C 35/08; B41F 33/00

(52) U.S. Cl. 264/401; 101/483

(57) ABSTRACT

A method of making a flexographic printing forme includes the steps of: (1) providing a flexographic support; (2) applying a powder layer on said the support; (3) imagewise jetting a curable composition on the powder layer; (4) at least partially curing the jetted curable composition; (5) repeating steps (2) to (4) until the total thickness of the powder layers is greater than 100 μm; (6) removal of the powder not embedded in the imagewise jetted and at least partially cured composition; and (7) optionally overall post curing.

### CROSS-REFERENCE TO RELATED APPLICATIONS

This application is a 371 National Stage Application of PCT/EP2008/061065, filed Aug. 25, 2008. This application claims the benefit of U.S. Provisional Application No. 60/971,670, filed Sep. 12, 2007, which is incorporated by reference herein in its entirety. In addition, this application claims the benefit of European Application No. 07116003.0, filed Sep. 10, 2007, which is also incorporated by reference herein in its entirety.

### BACKGROUND OF THE INVENTION

1. Field of the Invention

The present invention relates to a method of making a flexographic printing forme characterized in that the method includes the steps of:

(1) providing a flexographic support;
(2) applying a powder layer on the support;
(3) imagewise jetting a curable composition on the powder layer;
(4) at least partially curing the jetted curable composition; (5) repeating steps (2) to (4) until the total thickness of the powder layers is greater than 100 μm;
(6) removal of the powder not embedded in the imagewise jetted and at least partially cured composition; and
(7) optionally overall post curing.

2. Description of the Related Art

Flexography is today one of the most important processes for printing and commonly used for high-volume runs. Flexography is employed for printing on a variety of substrates such as paper, paperboard stock, corrugated board, films, foils and laminates. Packaging foils and grocery bags are prominent examples. Coarse surfaces and stretch films can only be economically printed with flexography, making it indeed very appropriate for packaging material printing.

Analogue flexographic printing formes are prepared from printing forme precursors including a photosensitive layer on a support or substrate. The photosensitive layer typically includes ethylenically unsaturated monomers or oligomers, a photo-initiator and an elastomeric binder. The support preferably is a polymeric foil such as PET or a thin metallic plate. Imagewise crosslinking of the photosensitive layer by exposure to ultraviolet and/or visible radiation provides a negative working printing forme precursor which after development with a suitable developer (aqueous, solvent or heat development) leaves a printing relief, which can be used for flexographic printing. Imaging of the photosensitive layer of the printing forme precursor with ultraviolet and/or visible radiation is typically carried out through a mask, which has clear and opaque regions. Crosslinking takes place in the regions of the photosensitive layer under the clear regions of the mask but does not occur in the regions of the photosensitive layer under the opaque regions of the mask. The mask is usually a photographic negative of the desired printed image. The analogue preparation of flexographic printing formes has as major disadvantages the time consuming production of a mask and the poor dimensional stability of the masks with changing environmental temperatures or humidities, making it sometimes unsatisfactory for high quality printing and colour registration. Moreover, the use of separate masks implies consumption of additional consumables and chemistry, with a negative impact on the economical and ecological aspects of the production process, which are often more a concern than the additional time required for making the masks.

Digital imaging, using laser recording, of flexographic printing forme precursors, eliminating the necessity of using a separate mask, is becoming increasingly important in the printing industry. The flexographic printing forme precursor is made laser sensitive by providing e.g. a thin, for UV and visual radiation opaque, infrared (IR) sensitive layer on top of the photopolymerizable layer. Such a flexographic printing forme precursor is typically called a “digital” or “direct-to plate” flexographic printing forme precursor. An example of such a “direct-to-plate” flexographic printing forme precursor is disclosed in EP-A 1 170 121. The thickness of the IR-ablative layer(s) is usually just a few μm. The IR-ablative layer is inscribed imagewise using an IR laser, i.e. the parts the laser beam is incident on are ablated and removed. The actual printing relief is produced in the conventional manner: exposure with actinic light (UV, visible) through the mask, the mask being imagewise opaque to the crosslinking inducing light, resulting in an imagewise crosslinking of the photopolymerizable layer, i.e. relief forming layer. Development with an organic solvent, water or heat removes the photosensitive material from the unexposed parts of the relief forming layer and the residues of the IR-ablative layer. Development may be performed using different developing steps or a single developing step. Since this method still requires a developing step, the improvement in efficiency for producing flexographic printing formes is limited.

In the direct laser engraving technique for the production of flexographic printing formes, a relief suitable for printing is engraved directly into a layer suitable for this purpose. By the action of laser radiation, layer components or their degradation products are removed in the form of hot gases, vapours, fumes, droplets or small particles and nonprinting indentations are thus produced. Engraving of rubber printing cylinders by means of lasers has been known since the late 60s of the last century. However, this technique has acquired broader commercial interest only in recent years with the advent of improved laser systems. The improvements in the laser systems include better focusing ability of the laser beam, higher power, multiple laser beam or laser source combinations and computer controlled beam guidance. Direct laser engraving has several advantages over the conventional production of flexographic printing plates. A number of time consuming process steps, such as the creation of a photographic negative mask or development and drying of the printing plate, can be dispensed with. Furthermore, the sidewall shape of the individual relief elements can be individually designed in the laser engraving technique.

The methods described above to prepare a flexographic printing forme are all subtractive methods, i.e. non printing areas are removed during wet or dry processing or by laser engraving. Inkjet printing provides an additive method to prepare a flexographic printing forme. For example EP-A 1 428 666 and EP-A 1 637 322 disclose a method of preparing a flexographic printing forme wherein a curable fluid is jetted on a support or substrate having an ink receiving surface. Advantages of such a method of preparing a flexographic printing forme are the absence of any processing steps and the consumption of no more material as necessary to form a suitable relief image (i.e. removal of non printing areas is no longer required).

Disadvantages of these inkjet methods to prepare flexographic printing formes are the constraints imposed on the jetting fluids. To ensure a sufficient jettability, the viscosity at jetting temperature of the curable jetting fluids may not be too high. For this reason, the type and amount of e.g. elastomeric compounds in the curable jetting fluids may be limited. Also, the presence of particles, e.g. elastomeric particles, in the curable jetting fluids may cause clogging of the printing nozzles. Due to these constraints on the curable jetting fluids, obtaining flexographic printing formes with optimum properties, such as flexibility, resilience, hardness, may be difficult to achieve with the conventional inkjet printing methods described above.

Various three-dimensional printing techniques are used in so called “rapid prototyping”. EP 431 924, U.S. Pat. No. 5,387,380 and U.S. Pat. No. 6,036,777 disclose a method and apparatus to form a three-dimensional image, to be used in “rapid prototyping”, wherein the method includes the steps of (i) depositing a first layer of a powder material in a confined region, (ii) depositing a binder material to selected regions of the layer of powder material to produce a layer of bonded powder material at selected regions, (iii) repeating steps (i) and (ii) a selected number of times to produce successive layers of selected regions of bonded powder so as to form the desired prototype. The unbonded powder material is then removed.

### SUMMARY OF THE INVENTION

Preferred embodiments of the present invention provide a method of preparing a flexographic printing forme by inkjet wherein the composition of the relief image may be optimized beyond the constraints imposed on the jettable fluids. In particular, the method enables the formation of a relief image including organic or inorganic particles. It is also a preferred embodiment of the present invention to provide a method of flexographic printing.

The above described advantages and benefits of the preferred embodiments of the present invention are realized by the method having the specific features as set out below. Further advantageous preferred embodiments of the invention are also set out below.

Other elements, features, steps, characteristics and advantages of the present invention will become more apparent from the following detailed description of the preferred embodiments with reference to the attached drawing.

### BRIEF DESCRIPTION OF THE DRAWINGS

FIG. 1 illustrates the formation of a flexographic printing forme according to a preferred embodiment of the present invention

### DETAILED DESCRIPTION OF THE INVENTION

The method according to a preferred embodiment of the present invention to prepare flexo-graphic printing formes includes the steps of:

(1) providing a flexographic support;
(2) applying a powder layer on the support;
(3) imagewise jetting a curable composition on the powder layer;
(4) at least partially curing the jetted curable composition; (5) repeating steps (2) to (4) until the total thickness of the powder layers is greater than 100 μm;
(6) removal of the powder not embedded in the imagewise jetted and at least partially cured composition; and
(7) optionally overall post curing the relief image.

### Flexographic Support

A flexographic support referred to in the methods of the present invention means a support with or without one or more cured layers, i.e. “elastomeric floor”, provided on it. Preferably, the flexographic support includes one or more cured layers provided on the relief forming side of the support.

As the support, any sheet like flexible material that is conventionally used to prepare flexographic printing formes may be used. For good printing results, a dimensionally stable support is required.

Examples of suitable support materials include polymeric films, such as those formed by addition polymers and linear condensation polymers, or metals, such as steel, aluminum, copper and nickel.

The support typically has a thickness from 0.002 to 0.050 inch (0.0051 to 0.127 cm), preferably from 0.003 to 0.016 inch (0.0076 to 0.040 cm).

Preferred polymeric supports are cellulose acetate propionate, cellulose acetate butyrate, polyesters such as polyethylene terephthalate (PET) and polyethylene naphthalate (PEN); oriented polystyrene (OPS); oriented nylon (ONy); polypropylene (PP), oriented polypropylene (OPP); polyvinyl chloride (PVC); and various polyamides, polycarbonates, polyimides, polyolefins, poly(vinylacetals), polyethers and polysulfonamides, opaque white polyesters and extrusion blends of polyethylene terephthalate and polypropylene. Acrylic resins, phenol resins, glass and metals may also be used. Other suitable supports can be found in Modern Approaches to Wettability: Theory and Applications. Edited by SCHRADER, Malcolm E., et al. New York: Plenum Press, 1992. ISBN 0306439859.

Additionally, one or more layers can be applied on the dimensionally stable support to optimize the properties of the flexographic printing forme, i.e. optimize receptivity and adhesion towards the relief image formed according to the methods of the present invention and optimize typical flexographic properties such as flexibility, resilience, elasticity, hardness, etc.

These one or more layers form the so called “elastomeric floor” of the flexographic printing forme. In conventional flexography, this “elastomeric floor” is formed by exposure of flexographic printing formes, including one or more photopolymerizable layers on a support, through the backside of the support. Such a back exposure results in curing part of the photopolymerizable layers nearest to the support, this part forming the “elastomeric floor”. The remaining non cured part is subsequently used to form the relief image. In the methods according to the present invention, completely cured conventional flexographic printing forme precursors may be used as supports. A wide variety of such conventional flexographic printing formes precursors are commercially available.

However, dedicated layer(s) may be applied to a flexographic support for use in preferred embodiments of the present invention.

These one or more layer(s) may have different compositions, e.g. the layer nearest to the support may be optimized towards an optimal adhesion between the “elastomeric floor” and the support, while the layer, on which the relief image will be jetted, may be optimized towards optimal adhesion between the relief image and the “elastomeric floor”, resulting in a higher run length, i.e. number of prints that can be made with one printing forme.

These one or more layers may be applied onto the support by various known coating techniques. The layers are preferably polymerizable layers. These polymerizable layers may be cured by exposure to actinic or IR radiation or by electron beam radiation. Curing may also be performed by applying heat to the coated layers. Preferably, the polymerizable layers are cured by exposure to UV light. Curing may be the result of crosslinking of polymers, of polymerization of monomers and/or oligomers, or of both.

Preferred polymerizable layers, provided on the flexographic support and forming the “elastomeric floor”, include an initiator and one or more curable compounds. The layers may further include an inhibitor, an elastomer, a plasticizer and further additives.

### Initiators

Preferred polymerizable layers forming the “elastomeric floor” include one or more initiator(s). The initiator typically initiates the polymerization reaction. The initiator may be a thermal initiator, but is preferably a photo-initiator.

Thermal initiator(s) suitable for use in the curable resin composition include tert-amyl peroxybenzoate, 4,4-azobis(4-cyanovaleric acid), 1,1′-azobis(cyclohexanecarbonitrile), 2,2′-azobisisobutyronitrile (AIBN), benzoyl peroxide, 2,2-bis(tert-butylperoxy)butane, 1,1-bis(tert-butylperoxy)cyclohexane, 1,1-Bis(tert-butylperoxy)cyclohexane, 2,5-bis(tert-butylperoxy)-2,5-dimethylhexane, 2,5-bis(tert-butylperoxy)-2,5-dimethyl-3-hexyne, bis(1-(tert-butylperoxy)-1-methylethyl)benzene, 1,1-bis(tert-butylperoxy)-3,3,5-trimethylcyclohexane, tert-butyl hydroperoxide, tert-butyl peracetate, tert-butyl peroxide, tert-butyl peroxy benzoate, tert-butylperoxy isopropyl carbonate, cumene hydro peroxide, cyclohexanone peroxide, dicumyl peroxide, lauroyl peroxide, 2,4-pentanedione peroxide, peracetic acid and potassium persulfate.

A photo-initiator produces initiating species, preferably free radicals, upon absorption of actinic radiation. A photo-initiator system may also be used. In the photo-initiator system, a photo-initiator becomes activated upon absorption of actinic radiation and forms free radicals by hydrogen or electron abstraction from a second compound. The second compound, usually called the co-initiator, becomes then the initiating free radical. Free radicals are high-energy species inducing polymerization of monomers or oligomers. When polyfunctional monomers and oligomers are present in the curable resin composition, the free radicals can also induce crosslinking. Curing may be realized by more than one type of radiation with different wavelength. In such cases it may be preferred to use more than one type of photo-initiator together.

A combination of different types of initiators, for example, a photo-initiator and a thermal initiator may also be used.

Suitable photo-initiators are disclosed in e.g. J. V. Crivello et al. in “Photoinitiators for Free Radical, Cationic & Anionic Photopolymerisation 2^{nd} edition”, Volume III of the Wiley/SITA Series In Surface Coatings Technology, edited by G. Bradley and published in 1998 by John Wiley and Sons Ltd London, pages 276 to 294.

Specific examples of photo-initiators may include, but are not limited to, the following compounds or combinations thereof: quinones, benzophenone and substituted benzophenones, hydroxy alkyl phenyl acetophenones, dialkoxy acetophenones, α-halogeno-acetophenones, aryl ketones such as 1-hydroxycyclohexyl phenyl ketone, 2-hydroxy-2-methyl-1-phenyl propan-1-one, 2-benzyl-2-dimethylamino-(4-morpholinophenyl)butan-1-one, thioxanthones such as isopropylthioxanthone, benzil dimethylketal, bis(2,6-dimethyl benzoyl)-2,4,4-trimethylpentylphosphine oxide, trimethylbenzoyl phosphine oxide derivatives such as 2,4,6 trimethylbenzoyl diphenylphosphine oxide, methyl thio phenyl morpholine ketones such as 2-methyl-1-[4-(methylthio)phenyl]-2-morpholinopropan-1-one, morpholino phenyl amino ketones, 2,2-dimethoxy-1,2-diphenylethan-1-one, 5,7-diiodo-3-butoxy-6-fluorone, diphenyliodonium fluoride and triphenylsulfonium hexafluophosphate, benzoin ethers, peroxides, biimidazoles, aminoketones, benzoyl oxime esters, camphorquinones, ketocoumarins and Michler's ketone.

Suitable commercial photo-initiators include IRGACURE 127, IRGACURE 184, IRGACURE 500, IRGACURE 907, IRGACURE 369, IRGACURE 1700, IRGACURE 651, IRGACURE 819, IRGACURE 1000, IRGACURE 1300, IRGACURE 1800, IRGACURE 1870, DAROCUR 1173, DAROCUR 2959, DAROCUR 4265 and DAROCUR ITX available from CIBA SPECIALTY CHEMICALS, LUCERIN TPO available from BASF AG, ESACURE KK, ESACURE KT046, ESACURE KT055, ESACURE KIP150, ESACURE KT37 and ESACURE EDB available from LAMBERTI, H-Nu 470 and H-Nu 470X available from SPECTRA GROUP Ltd., GENOCURE EHA and GENOCURE EPD from RAHN.

Since curing is preferably realized with UV-radiation, the preferred photo-initiators absorb UV radiation.

To improve in depth curing, it may be advantageous to use an initiator system that decreases in UV absorbance as polymerization proceeds, as disclosed in US 2002/0123003 paragraph [0021].

Particular preferred photo-initiators are IRGACURE 651 and IRGACURE 127.

Suitable cationic photo-initiators include compounds, which form aprotic acids or Bronstead acids upon exposure sufficient to initiate polymerization. The photo-initiator used may be a single compound, a mixture of two or more active compounds, or a combination of two or more different compounds, i.e. co-initiators. Non-limiting examples of suitable cationic photo-initiators are aryldiazonium salts, diaryliodonium salts, triarylsulphonium salts, triarylselenonium salts and the like.

Sensitizing agents may also be used in combination with the initiators described above. In general, sensitizing agents absorb radiation at a wavelength different then the photo-initiator and are capable of transferring the absorbed energy to that initiator, resulting in the formation of e.g. free radicals.

The amount of initiator is preferably from 1 to 10% by weight, more preferably from 2 to 8% by weight, relative to the total weight of non-volatile ingredients of the polymerizable layer.

### Curable Compounds

Preferred polymerizable layers forming the “elastomeric floor” include one or more curable compounds. These curable compounds may include one or more polymerizable groups, preferably radically polymerizable groups.

Any polymerizable mono- or oligofunctional monomer or oligomer commonly known in the art may be employed. Preferred monofunctional monomers are described in EP-A 1 637 322 paragraph to [0057]. Preferred oligofunctional monomers or oligomers are described in EP-A 1 637 322 paragraphs [0059] to [0064].

The selection of curable compounds determines the properties of the cured polymerized layers, e.g. flexiblity, resilience, hardness, adhesion of the relief image.

A particularly preferred curable compound is an urethane (meth)acrylate oligomer. It has been found that the presence of urethane (meth)acrylate oligomers, preferably in an amount of 40% by weight or more, relative to the total weight of the non-volatile ingredients of the polymerizable layer, provides excellent printing properties to the flexographic printing formes. The urethane (meth)acrylate oligomer may have one, two, three or more polymerizable groups. Preferably the urethane (meth)acrylate oligomers have one or two polymerizable groups.

Commercially available urethane (meth)acrylates are e.g. CN9170, CN910A70, CN966H90, CN962, CN965, CN9290 and CN981 from SARTOMER; BR-3741B, BR-403, BR-7432, BR-7432G, BR-3042, BR-3071 from BOMAR SPECIALTIES CO.; NK Oligo U-15HA from SHIN-NAKAMURA CHEMICAL CO. Ltd.; ACTILANE 200, ACTILANE SP061, ACTILANE 276, ACTILANE SP063 from AKZO-NOBEL; Ebecryl 8462, EBECRYL 270, EBECRYL 8200, EBECRYL CL-1039, EBECRYL 285, EBECRYL 4858, EBECRYL 210, EBECRYL 220, EBECRYL 1039, EBECRYL 1259 and IRR160 from CYTEC; GENOMER 1122 and GENOMER 4215 from RAHN A.G.

To optimize the viscosity of the curable composition forming the polymerizable layers, one or more monomers and/or oligomers are used as diluents. Preferred monomers and/or oligomers acting as diluents are miscible with the above described urethane (meth)acrylate oligomers. Particularly preferred monomers and/or oligomers acting as diluents do not adversely affect the properties of the cured resin composition.

The monomers and/or oligomers may have a functionality up to three. However, mono or difunctional monomers and/or oligomers are preferred. Most preferably, low viscosity (meth)acrylate monomers are used. Particularly preferred monomers and/or oligomers acting as diluents are: SR344, a polyethyleneglycol (400) diacrylate; SR604, a polypropylene monoacrylate; SR9003, a propoxylated neopentyl glycol diacrylate; SR610, a polyethyleneglycol (600) diacrylate; SR531, a cyclic trimethylolpropane formal acrylate; SR340, a 2-phenoxyethyl methacrylate; SR506D, an isobornyl acrylate; SR285, a tetrahydrofurfuryl acrylate all from SARTOMER or CRAY VALLEY; Miramer M100, a dicaprolactone acrylate and GENOMER 1122, a monofunctional urethane acrylate from RAHN; BISOMER PEA6, a polyethyleneglycol monoacrylate from COGNIS; EBECRYL 1039, a very low viscous urethane monoacrylate; EBECRYL 11, a polyethylene glycol diacrylate; EBECRYL 168, an acid modified methacrylate, EBECRYL 770, an acid functional polyester acrylate diluted with 40% hydroxyethylmethacrylate from UCB and CN137, a low viscosity aromatic acrylate oligomer from CRAYNOR.

### Inhibitors

In order to prevent premature thermal polymerization, the polymerizable layers may contain a polymerization inhibitor. Suitable polymerization inhibitors include phenol type antioxidants, hindered amine light stabilizers, phosphor type antioxidants, hydroquinone monomethyl ether, hydroquinone, t-butyl-catechol or pyrogallol.

Suitable commercial inhibitors are, for example, SUMILIZER GA-80, SUMILIZER GM and SUMILIZER GS produced by Sumitomo Chemical Co. Ltd.; GENORAD 16, GENORAD 18 and GENORAD 20 from Rahn AG; IRGASTAB UV10 and IRGASTAB UV22, TINUVIN 460 and CGS20 from Ciba Specialty Chemicals; FLOORSTAB UV range (UV-1, UV-2, UV-5 and UV-8) from Kromachem Ltd, Additol S range (S100, S110, S120 and S130) from Cytec Surface Specialties.

Since excessive addition of these polymerization inhibitors will lower the curing efficiency, the amount is preferably lower than 2% by weight relative to the total weight of the non-volatile ingredients of the polymerizable layer.

### Elastomers

To further optimize the properties of the flexographic printing forme precursor the polymerizable layers may further include one or more elastomeric compounds. Suitable elastomeric compounds include copolymers of butadiene and styrene, copolymers of isoprene and styrene, styrene-diene-styrene triblock copolymers, polybutadiene, polyisoprene, nitrile elastomers, polyisobutylene and other butyl elastomers, polyalkyleneoxides, polyphosphazenes, elastomeric polyurethanes and polyesters, elastomeric polymers and copolymers of (meth)acrylates, elastomeric polymers and copolymers of olefins, elastomeric copolymers of vinylacetate and its partially hydrogenated derivatives.

### Plasticizers

Plasticizers are typically used to improve the plasticity or to reduce the hardness of the flexographic printing forme precursor. Plasticizers are liquid or solid, generally inert organic substances of low vapor pressure.

Suitable plasticizers include modified and unmodified natural oils and resins, alkyl, alkenyl, arylalkyl or arylalkenyl esters of acids, such as alkanoic acids, arylcarboxylic acids or phosphoric acid; synthetic oligomers or resins such as oligostyrene, oligomeric styrene-butadiene copolymers, oligomeric α-methylstyrene-p-methylstyrene copolymers, liquid oligobutadienes, or liquid oligomeric acrylonitrile-butadiene copolymers; and also polyterpenes, polyacrylates, polyesters or polyurethanes, polyethylene, ethylene-propylene-diene rubbers, α-methyloligo (ethylene oxide), aliphatic hydrocarbon oils, e.g., naphthenic and paraffinic oils; liquid polydienes and liquid polyisoprene.

Examples of particularly suitable plasticizers are paraffinic mineral oils; esters of dicarboxylic acids, such as dioctyl adipate or dioctyl terephthalate; naphthenic plasticizers or polybutadienes having a molar weight of between 500 and 5,000 g/mol.

More particularly preferred plasticizers are HORDAFLEX LC50 available from HOECHST, SANTICIZER 278 available from MONSANTO, TMPME available from PERSTORP AB, and PLASTHALL 4141 available from C. P. Hall Co.

It is also possible to use a mixture of different plasticizers.

Preferred plasticizers are liquids having molecular weights of less than 5,000, but can have molecular weights up to 30,000.

### Other Additives

The polymerizable layers may further include other additives such as dyes, pigments, photochromic additives, anti-oxidants, antiozonants and tack-reducing additives. Examples of tack-reducing additives are for example aromatic carboxylic acids, aromatic carboxylic acid esters, polyunsaturated carboxylic acids, polyunsaturated carboxylic acid esters of mixtures thereof. The amount of additives is preferably less than 20% by weight based on the sum of all non-volatile constituents of the polymerizable layer, and is advantageously chosen so that the overall amount of plasticizer and additives does not exceed 50% by weight based on the sum of all the constituents.

### Liquid Photopolymers

Highly preferred, commercially available liquid photopolymers, e.g. VERBATIM liquid photopolymer resins form Chemence, such as for example VERBATIM HR50, are used to prepare the “elastomeric floor”. A wide range of liquid photopolymer products are available, each product resulting upon coating and curing in layers having particular properties, e.g. different Shore A hardness. When the “elastomeric floor” is formed by more then one layer, different liquid photopolymers may be used in each different layer.

The polymerizable layers forming the “elastomeric floor” may consist essentially of such a commercially available liquid photopolymer and a photo-initiator, such as e.g. Irgacure 127. Preferably however, these liquid photopolymers are used in combination with the diluent monomers and/or oligomers described above to optimize the viscosity of the curable composition.

The type and amount of monomers and/or oligomers and optionally further compounds described above are selected to realize optimal properties of the “elastomeric floor” such as flexibility, resilience, hardness, adhesion to the substrate and adhesion of the relief image. It may be advantageous that the curable composition forming the outermost layer of the “elastomeric floor” includes ingredients compatible with those of curable compositions used to form the relief image by inkjet, to optimize the adhesion between the relief image and the “elastomeric floor”.

Thickness of the Layers

The total thickness of the photopolymerizable layers may be chosen by the skilled worker in accordance with the requirements of the desired application. The total thickness may vary from 0.2 to 3 mm, more preferably from 0.3 to 1.5 mm, most preferably from 0.4 to 1.2 mm. Compared to commercially available photopolymerizable flexographic printing forme precursors, to be used in conventional flexographic printing forme formation whereby both the “elastomeric floor” and the relief image are formed by the photopolymerizable layers, the total thickness of the layers in the preferred embodiments of the present invention may be lower because the layers are only used to from the “elastomeric floor” and not the relief image.

The “elastomeric floor” has preferably a Shore A hardness of from 30 to 80.

### Coating and Curing of the Polymerizable Layers on a Support

The polymerizable layers may be provided onto a support by any conventional method such as coating, extrusion or cast molding. The curable compositions may be provided on the substrate while heating.

After applying the polymerizable layers on a support, the layers are cured by irradiation or heat. Heat may be used to cure (i.e. polymerize) when the compositions includes a thermal initiator, as described above. Irradiation may be electron beam irradiation or actinic irradiation, preferably actinic irradiation. Curing with electron beam irradiation does not necessitate the presence of an initiator in the curable composition(s). The suitability of a particular actinic radiation source is governed by the photo-sensitivity of the initiator used in preparing the flexographic printing forme precursor. The preferred photosensitivity of most common flexographic printing forme precursors is in the UV and deep UV region of the spectrum. Examples of suitable radiation sources include carbon arcs, mercury-vapor arcs, fluorescent lamps, electron flash units, electron beam units, lasers, LEDs and photographic flood lamps. Preferred sources of UV radiation are the mercury vapor lamps. UV radiation is generally classified as UV-A, UV-B and UV-C as follows:

### UV-A: 400 nm to 320 nm

### UV-B: 320 nm to 290 nm

### UV-C: 290 nm to 100 nm

It may be advantageous to use two radiation sources to perform the curing. For example, the first UV source may be selected to be an UV-A radiation source while the second UV source may be selected to be an UV-C radiation source. The second curing step is often referred to as a post curing step, to obtain non-tacky surfaces.

However, in the method of preparing a flexographic printing forme according to a preferred embodiment of present invention, partially cured layers, for example obtained by a short UV-A curing without performing a UV-C curing, may result in an improved adhesion with the relief image jetted on it. A possible explanation may be the presence of unreacted monomers in the partially cured uniform layer, which may cure together with the monomers of the jetted relief image, upon overall curing.

When more than one polymerizable layers are provided on a support, curing may be performed after providing all of the layers on the support or alternatively curing may be performed after each layer has been provided on the support. When one or more layers are present, partially curing the outermost layer may be beneficial towards the adhesion of the relief image on it.

The curing time will vary depending on the intensity and spectral energy distribution of the radiation, the distance between the light source and the printing element, the composition and thickness of the polymerizable layers of the “elastomeric floor”.

A removable coversheet may be present during curing, to minimize the inhibition of the polymerization by oxygen. Another method to minimize the inhibition by oxygen is performing the curing under inert N₂ or CO₂ atmosphere.

In another preferred embodiment of the present invention, the “elastomeric floor” may also be applied on a support by:

(1) applying a powder layer to a support;
(2) jetting a layer of a curable composition on the powder layer thereby forming a layer consisting of the powder embedded in the curable composition;
(3) at least partially curing the layer;
(4) repeating steps (1), (2) and (3) until a desired thickness of the elastomeric floor is obtained.

The powder and the curable composition used to form the elastomeric floor are described in the section dealing with the formation of the relief image according to a preferred embodiment of the present invention.

The powder and the curable composition used to form the elastomeric floor and the relief image may be the same or may be different. The “elastomeric floor” may be formed with one type of powder and curable composition or may be formed with different types of powder and/or curable compositions. For example the layers formed nearest to the support may be different, i.e. different powder and/or curable compositions, compared to the outermost layers.

### Powder

A suitable powder (i) enables the application of a uniform powder layer, (ii) enhances the required properties such as flexibility, elasticity, resilience, hardness of the flexographic printing forme obtained, (iii) is wettable by the curable compositions used and (iv) is easily removable upon completion of the flexographic printing forme.

The powder may be inorganic or organic.

Examples of an inorganic powder, typically used as filler material in various composite materials, which may be used in the present invention, are e.g. talc, glass, calcium carbonate, magnesium carbonate, titanium oxide, zinc oxide, silica, nanoclays, etc. Other examples of inorganic powders are graphite powder having a particle size of 70 μm or less; Al₂O₃ particles; Barrierflex powder, a special blend of powders used as a flexible adhesive for internal and external fixing of ceramic tiles; alumina silicates; Fly ash, a powder consisting of inorganic incombustible matter present in coal that has been fused during combustion into a glassy, amorphous structure; Bentonite or Fuller's earth clay; cement powder, calcium aluminate powder and sodium silicate.

The surface of these inorganic powders may be modified to enhance their wettability by the curable compositions.

Also various organic powders may be used. The particles of the powders may have any particulate shape, however spherical particle shapes are preferred. Such organic powders may be obtained by pulverization techniques or by special polymerization techniques resulting in (spherical) particles, e.g. emulsion polymerization. Preferably, elastomeric organic powders are used.

An example of an organic powder is starch, commercially used for example by Z-Corporation in their 3D rapid prototyping printers.

Other examples of organic powders consist of condensation polymers such as polyester, polyurethane and polyamide. Epoxy elastomeric polymers prepared by dispersion polymerization techniques may also be used. Elastomeric addition (co)polymers such as acrylates and methacrylates with low glass transition temperatures, for example ethyl acrylate, n-propyl acrylate, beta-ethoxyethylmethacrylate, 2-ethylhexyl acrylate octadecyl methacrylate may be used either alone or preferably with a monomer difunctional with respect to the polymerization reaction, for example ethyleneglycol dimethacrylate, to impart a controlled degree of crosslinking. The degree of crosslinking may be important since it may influence the swelling characteristics of the particles, a low degree of crosslinking typically increases the swelling property and the glass transition temperature, a high degree of crosslinking typically increases the glass transition temperature and may decrease the elastomeric properties.

Still other examples of organic powders contain organic particles of nitrile rubbers, hydrogenated nitrile rubbers, ethylene-propylene rubbers, copolymers of vinylacetate and ethylene terpolymers of ethylene, propylene and a non-conjugated diene, natural rubbers, polybutadiene, polyisobutadiene, butyl rubber, halogenated butyl rubber, copolymers of butadiene with one or more polymerizable ethylenically unsaturated monomers such as styrene, acrylonitrile, methyl methacrylate, polyacrylates, polyethers and polymers of substituted butadienes such as chlorobutadiene and isoprene.

Any type of natural or synthetic rubber polymer or copolymer may be used as powder in the present invention, provided that the rubber can be ground or is obtained in powder form. Grounding may be performed by any milling technique, for example a disk attrition mill. Fillers may be integrated into the rubber to improve the tear-and-wear resistance of the rubber.

In another preferred embodiment, the organic powders are designed to contain polymerizable groups at the surface of the organic particles. These polymerizable groups may result in a crosslinking of the particles with the imagewise jetted curable compositions upon curing, thereby further improving the flexographic properties of the obtained flexographic printing forme. For example, when using polyester particles, in the dispersion polymerization of saturated polyester elastomeric particles from adipic acid, glycerol and diethyleneglycol, ethylenic unsaturation may be introduced into the surface region of the particles by the addition of itaconic acid in the latter stages of the polymerization reaction. Similarly, elastomeric particles from addition polymers, for example polyethylacrylate crosslinked with a small amount of ethylene glycol dimethacrylate may be modified by adding glycidyl methacrylate during the last stages of the dispersion polymerization of ethyl acrylate. The epoxide group of the glycidyl methacrylate can then be reacted with for example hydroxyethylmethacrylate to provide unsaturation in the surface region.

Other organic powders that may be used in the present invention are ALCOTAC FE4, supplied as a very fine powder (<200 μm) by Ciba Geigy; polyvinylalcohol powders; AVICEL, a microcrystalline cellulose; powdered bitumen; Gilsonite and Corn starch.

Preferably the particles of the powders are “free flowing”, i.e. having only little or no aggregation tendency, to ensure the easy formation of a uniform powder layer. To improve the “free flowing” behaviour, the particles may be surface treated. A surface treatment may also improve the wetting properties of the particles by the curable composition jetted on the powder. The wetting property is very important to form, upon jetting the curable composition on the powder, one layer consisting of the powder embedded in the curable composition. Formation of two separate layers, i.e. a layer of the jetted and cured composition and a powder layer must be avoided, since this will result in inferior properties of the obtained flexographic printing forme.

The particle size of the powder is preferably 100 μm or less, more preferably 20 μm or less.

The density of the powder may also influence the embedding of the particles in the jetted composition. When the density of the powder is (much) smaller than the density of the jetted composition, it may happen that the powder will “float” on the jetted composition. Preferably, the density of the powder is equal than or greater than the density of the jetted composition. The density of a preferred jetting fluid is from 1.00 to 1.20, more preferably from 1.05 to 1.10 g/cm³.

In a particular preferred embodiment, a powder of elastomeric polymer particles are used in the present invention in view of optimizing the elastomeric properties of the obtained flexographic printing forme.

The powders may not adversely affect the printing properties, i.e. ink receptive, properties of the obtained flexographic printing forme. Therefore, ink adhesive particles, e.g. silicone containing particles, are preferably not used in the present invention.

### Applying the Powders

Upon applying the powder on the flexographic substrate, a powder layer, preferably having a homogeneous thickness, is formed. The thickness of the individual powder layer is preferably between 5 and 500 μm, more preferably between 10 and 250 μm. The total thickness of the powder layers applied on the flexographic support is greater than 100 μm, more preferably greater than 200 μm.

Any technique, for example those described in U.S. Pat. No. 5,387,380, may be used to apply the powder on the flexographic substrate.

For example the powder may be applied with one or more dispensing head(s) moving along the length of the substrate. After dispensing the powder, a doctor blade may be used to obtain the desired homogeneous thickness or a roller may be used to spread the powder over the substrate. After dispensing the powder, a desired compaction of the material may be achieved using mechanical vibrating compaction techniques or by applying acoustic energy, i.e. sonic or ultrasonic vibration.

The powder may also be applied to the substrate in a liquid vehicle. Residual solvent after applying the powder may be present as long as the residual solvent does not cause wetting problems between the powder and the curable jetting liquids and does not adversely affect the removal of the excess powder upon completion of the relief image. Preferably, a drying step is applied before imagewise jetting of the curable jetting liquids.

To obtain homogeneous and densely packed layers, it is preferred that the powder has spherical particles.

### Curable Jettable Liquid

The curable jettable liquid suitable for the method for preparing a flexographic printing forme according to a preferred embodiment of the present invention preferably contains at least (i) a monofunctional monomer, (ii) a polyfunctional monomer or oligomer, (iii) a photo-initiator and optionally (iv) a plasticizer. The curable jettable liquid may further contain a polymerization inhibitor to restrain polymerization by heat or actinic radiation, an acid functionalized monomer or oligomer, an elastomer, a surfactant for controlling the spreading of the curable jettable liquid droplet, a colorant for increasing the contrast between the jetted image and the background. The curable jettable liquid may further contain water and/or organic liquids, such as alcohols, fluorinated solvents and dipolar aprotic liquids.

The curable jettable liquid may also further contain a humectant, a biocide to prevent unwanted microbial growth over time. In addition, the curable jettable liquid may further contain additives such as buffering agents, anti-mold agents, pH adjustment agents, electric conductivity adjustment agents, chelating agents, anti-rusting agents and light stabilizers. Such additives may be incorporated in the curable jettable liquid in any effective amount, as desired. Examples of pH controlling agents suitable for curable jettable liquid include, but are not limited to, acids, and bases, including hydroxides of alkali metals such as lithium hydroxide, sodium hydroxide and potassium hydroxide.

The curable jettable liquid preferably has a viscosity at a shear rate of 100 s⁻¹ and at a temperature between 15 and 70° C. of not more than 100 mPa·s, preferably less than 50 mPa·s, and more preferably less than 15 mPa·s.

### Monofunctional Monomers

Any polymerizable monofunctional monomer commonly known in the art may be employed. Particular preferred polymerizable monofunctional monomers are disclosed in EP 1 637 926 paragraph [0054] to [0058].

Two or more monofunctional monomers can be used in combination.

The monofunctional monomer preferably has a viscosity smaller than 30 mPa·s at a shear rate of 100 s⁻¹ and at a temperature between 15 and 70° C.

### Polyfunctional Monomers and Oligomers

Any polymerizable polyfunctional monomer and oligomer commonly known in the art may be employed. Preferred polyfunctional monomers and oligomers are disclosed in EP 1 637 926 paragraph [0059] to [0063] and are those disclosed in the present application for the polymerizable layers provided on the flexographic support.

Two or more polyfunctional monomers and/or oligomers can be used in combination.

The polyfunctional monomer or oligomer preferably has a viscosity higher than 50 mPa·s at a shear rate of 100 s⁻¹ and at a temperature between 15 and 70° C.

### Acid Functionalized Monomers and Oligomers

Any polymerizable acid functionalized monomer and oligomer commonly known in the art may be employed. Particular preferred acid functionalized monomers and oligomers are disclosed in EP 1 637 926 paragraph [0066] to [0070].

### Photo-Initiators

The photo-initiator, upon absorption of actinic radiation, preferably UV-radiation, forms high-energy species, preferably free radicals inducing polymerization and crosslinking of the monomers and oligomers in the jettable curable liquid.

A preferred amount of photo-initiator is 1 to 10% by weight, more preferably 1 to 7% by weight, of the total curable jettable liquid weight.

A combination of two or more photo-initiators may be used. A photo-initiator system, including a photo-initiator and a co-initiator, may also be used. A suitable photo-initiator system includes a photo-initiator, which upon absorption of actinic radiation forms free radicals by hydrogen abstraction or electron extraction from a second compound, the co-initiator. The co-initiator becomes the actual initiating free radical.

Irradiation with actinic radiation may be realized in two steps, each step using actinic radiation having a different wavelength and/or intensity. In such cases it is preferred to use 2 types of photo-initiators, chosen in function of the different actinic radiation used.

Suitable photo-initiators are disclosed in EP 1 637 926 paragraph [0077] to [0079] and are those disclosed in the present application for the polymerizable layers provided on the flexographic support.

### Inhibitors

Suitable polymerization inhibitors include phenol type antioxidants, hindered amine light stabilizers, phosphor type antioxidants, hydroquinone monomethyl ether commonly used in (meth)acrylate monomers, and hydroquinone, methylhydroquinone, t-butylcatechol, pyrogallol may also be used. Of these, a phenol compound having a double bond in molecules derived from acrylic acid is particularly preferred due to its having a polymerization-restraining effect even when heated in a closed, oxygen-free environment. Suitable inhibitors are, for example, SUMILIZER® GA-80, SUMILIZER® GM and SUMILIZER® GS produced by Sumitomo Chemical Co., Ltd.

Since excessive addition of these polymerization inhibitors will lower the sensitivity to curing of the curable jettable liquid, it is preferred that the amount capable of preventing polymerization be determined prior to blending. The amount of a polymerization inhibitor is generally between 200 and 20,000 ppm of the total curable jettable liquid weight.

### Oxygen Inhibition

Suitable combinations of compounds which decrease oxygen polymerization inhibition with radical polymerization inhibitors are: 2-benzyl-2-dimethylamino-1-(4-morpholinophenyl)-butane-1 and 1-hydroxy-cyclohexyl-phenyl-ketone; 1-hydroxy-cyclohexyl-phenyl-ketone and benzophenone; 2-methyl-1[4-(methylthio)phenyl]-2-morpholino-propane-1-on and diethylthioxanthone or isopropylthioxanthone; and benzophenone and acrylate derivatives having a tertiary amino group, and addition of tertiary amines. An amine compound is commonly employed to decrease an oxygen polymerization inhibition or to increase sensitivity. However, when an amine compound is used in combination with a high acid value compound, the storage stability at high temperature tends to be decreased. Therefore, specifically, the use of an amine compound with a high acid value compound in ink-jet printing should be avoided.

Synergist additives may be used to improve the curing quality and to diminish the influence of the oxygen inhibition. Such additives include, but are not limited to ACTILANE® 800 and ACTILANE® 725 available from AKZO NOBEL, EBECRYL® P115 and EBECRYL® 350 available from UCB CHEMICALS and CD 1012, Craynor CN 386 (amine modified acrylate) and Craynor CN 501 (amine modified ethoxylated trimethylolpropane triacrylate) available from CRAY VALLEY.

The content of the synergist additive is in the range of 0 to 50% by weight, preferably in the range of 5 to 35% by weight, based on the total weight of the curable jettable liquid.

### Plasticizers

Plasticizers are usually used to improve the plasticity or to reduce the hardness of adhesives, sealing compounds and coating compositions. Plasticizers are liquid or solid, generally inert organic substances of low vapor pressure.

Suitable plasticizers are disclosed in EP 1 637 926 paragraph [0086] to [0089] and are those disclosed in the present application for the polymerizable layers provided on the flexographic support.

The amount of plasticizer is preferably at least 5% by weight, more preferably at least 10% by weight, each based on the total weight of the curable jettable liquid.

The plasticizers may have molecular weights up to 30,000 but are preferably liquids having molecular weights of less than 5,000.

### Elastomers

The elastomer may be a single binder or a mixture of various binders. The elastomeric binder is an elastomeric copolymer of a conjugated diene-type monomer and a polyene monomer having at least two non-conjugated double bonds, or an elastomeric copolymer of a conjugated diene-type monomer, a polyene monomer having at least two non-conjugated double bonds and a vinyl monomer copolymerizable with these monomers.

Preferred elastomers are disclosed in EP 1 637 926 paragraph [0092] and [0093] and are those disclosed in the present application for the polymerizable layers provided on the flexographic support.

### Surfactants

The surfactant(s) may be anionic, cationic, non-ionic, or zwitter-ionic and are usually added in a total quantity below 20% by weight, more preferably in a total quantity below 10% by weight, each based on the total curable jettable liquid weight.

A fluorinated or silicone compound may be used as a surfactant, however, a potential drawback is bleed-out after image formation because the surfactant does not cross-link. It is therefore preferred to use a copolymerizable monomer having surface-active effects, for example, silicone-modified acrylates, silicone modified methacrylates, fluorinated acrylates, and fluorinated methacrylates.

### Colorants

Colorants may be dyes or pigments or a combination thereof. Organic and/or inorganic pigments may be used. Suitable dyes include direct dyes, acidic dyes, basic dyes and reactive dyes.

Suitable pigments are disclosed in EP 1 637 926 paragraphs [0098] to [0100].

The pigment is present in the range of 0.01 to 10% by weight, preferably in the range of 0.1 to 5% by weight, each based on the total weight of curable jettable liquid.

### Solvents

The curable jettable liquid preferably does not contain an evaporable component, but sometimes, it can be advantageous to incorporate an extremely small amount of a solvent to improve adhesion to the ink-receiver surface after UV curing. In this case, the added solvent may be any amount in the range of 0.1 to 10.0% by weight, preferably in the range of 0.1 to 5.0% by weight, each based on the total weight of curable jettable liquid.

### Humectants

When a solvent is used in the curable jettable liquid, a humectant may be added to prevent the clogging of the nozzle, due to its ability to slow down the evaporation rate of curable jettable liquid.

Suitable humectants are disclosed in EP 1 637 926 paragraph [0105]. A humectant is preferably added to the curable jettable liquid formulation in an amount of 0.01 to 20% by weight of the formulation, more preferably in an amount of 0.1 to 10% by weight of the formulation.

### Biocides

Suitable biocides include sodium dehydroacetate, 2-phenoxyethanol, sodium benzoate, sodium pyridinethion-1-oxide, ethyl p-hydroxy-benzoate and 1,2-benzisothiazolin-3-one and salts thereof. A preferred biocide for the curable jettable liquid suitable for the method for manufacturing a flexographic printing plate according to the present invention, is PROXEL® GXL available from ZENECA COLOURS.

A biocide is preferably added in an amount of 0.001 to 3% by weight, more preferably in an amount of 0.01 to 1.00% by weight, each based on curable jettable liquid.

### Preparation of a Curable Jettable Liquid

The curable jettable liquids may be prepared as known in the art by mixing or dispersing the ingredients together, optionally followed by milling, as described for example in EP 1 637 322 paragraph [0108] and [0109].

### Forming Relief Image

Any known inkjet method to build relief images may be used, in particular the methods described in EP 1 428 666, EP 1 437 882 and EP 1 637 322.

A preferred inkjet printing head is a piezoelectric head. Piezoelectric inkjet printing is based on the movement of a piezoelectric ceramic transducer when a voltage is applied thereto. The application of a voltage changes the shape of the piezoelectric ceramic transducer in the printing head creating a void, which is then filled with fluid. When the voltage is again removed, the ceramic expands to its original shape, ejecting a drop of fluid from the print head. However the inkjet printing method used in the present invention is not restricted to piezoelectric inkjet printing. Other inkjet printing heads can be used and include various types, such as a continuous type and thermal, electrostatic and acoustic drop on demand type.

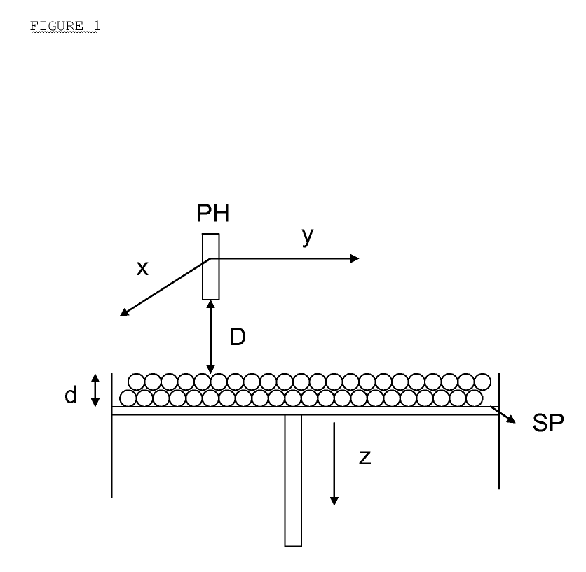

A preferred embodiment of the present invention is depicted in FIG. 1.

The flexographic support (SP) is mounted in a “trough”. On the support (SP) a layer of powder is applied, the layer having a thickness d.

The print head (PH) is positioned at a constant distance D of the outermost powder layer deposited on the support (SP). The print head (PH) moves along the X and Y direction to imagewise deposit a curable fluid on the outermost powder layer to form a layer of the relief image. This layer of the relief image consists of the powder embedded in the curable fluid. Preferably a layer is formed wherein the powder is completely embedded in or saturated with the curable fluid jetted on it. Therefore, the amount of curable fluid, imagewise jetted on the powder layer, is preferably adapted as function of the thickness of the powder layer. After one layer of the relief image is formed, the support (SP) in the trough is moved in de z direction over a distance d, followed by applying a subsequent powder layer, having a thickness d, on top of previous layer of the relief image already formed. These steps are repeated until the complete relief image is formed.

One or more print heads may be used in the present invention. Using more than one print head may speed up the process of making the relief image. A “single pass printing process” using page wide inkjet printing heads or multiple staggered inkjet printing heads covering the entire width of the support may also be used in the present invention.

After imagewise providing a layer of the curable composition on the powder and before applying the subsequent powder layer a curing step is carried out. Curing is preferably carried out by irradiation, most preferably by UV radiation.

Examples of suitable radiation sources are described in the present application for curing of the polymerizable layers provided on the flexographic support.

It may be advantageous to use two radiation sources to perform the curing. For example, the first UV source may be selected to be an UV-A source while the second UV source may be selected to be an UV-C radiation source. The second curing step is often referred to as a post curing step, to obtain non-tacky surfaces.

The curing time will vary depending on the intensity and spectral energy distribution of the radiation, the distance between the light source and the printing element, the composition and the amount of the jetted layer of curable fluid and the spectral properties of the powder. The amount of the curable fluid, imagewise jetted on the powder layer, will depend on the thickness of the layer of powder, to ensure complete saturation of the powder with the curable fluid. The amount of jetted curable liquid preferably increases with increasing thickness of the layer of powder. If necessary, more than one droplet of curable fluid is imagewise jetted to ensure complete saturation of the powder layer.

It may be advantageous in order to increase the adhesion between two imagewise applied layers to only partially cure the different layers. Partial curing may be performed for example by UV-A curing the layer during a short enough time. The residual monomers within one layer, not reacted during partial curing, may crosslink with residual monomers within the neighbouring layer, and therefore increase the adhesion between both layers upon overall curing of the relief image.

Upon completion, the excess powder not embedded in the at least partially cured imagewise jetted composition is removed preferably by blowing air or by cleaning the flexographic printing forme with a solution, preferably an aqueous solution. Preferably the excess powdery is recycled and reused. After removal of the excess powder, the relief image is obtained, the relief image being composed of powder embedded in at least partially cured composition.

After forming the relief image, an overall curing, using the curing means as described above, may be performed.

### EXAMPLES

### Materials

All materials used in the following examples were readily available from Aldrich Chemical Co. (Belgium) unless otherwise specified.

The following materials were used:
DPGDA is a dipropylene glycol diacrylate available from UCB.
EBECRYL 11 is a polyethylene glycol diacrylate available from UCB.
EBECRYL 168 is an acid modified methacrylate available from UCB.
EBECRYL 770 is an acid functional polyester acrylate diluted with 40% HEMA (hydroxyethylmethacrylate) available from UCB.
SANTICIZER 278, a benzyl phthalate plasticizer from MONSANTO.
SARTOMER 506D is an isobornyl acrylate available from CRAY VALLEY.
IRGACURE 500, a photo-initiators available from CIBA SPECIALTY CHEMICALS.
PERENOL S is 50 wt % solution of Perenol S Konz. (available from COGNIS) in ethyl acetate.
SYLOID W300, SiO₂ from GRACE GMBH.
SYLYSIA 450, an amorphous silica, particle size between 7.1 and 9.4 μm, surface area 300 m²/g, from QOLORTECH BV.
SYLYSIA 456, an amorphous silica with a hydrocarbon surface treatment, particle size between 7.1 and 9.4 μm, from QOLORTECH BV.
SYLYSIA 770, an amorphous silica, particle size between 5.4 and 8.0 μm, surface area 700 m²/g, from QOLORTECH BV.
Latex LX, a dry styrene-acrylonitrile (60/40 mol %) latex having a particle size of 43 nm, measured with a PL-PSDA apparatus (Polymer Laboratories Particle Size Diameter Analyser) from Polymer Laboratories Ltd, Church Stretton, Shropshire, UK.

### Example 1

### Preparation of the Inkjet Fluid IF-01

A curable inkjet fluid IF-01 was prepared by mixing the ingredients listed in Table 1 together at room temperature while stirring.

TABLE 1

| Ingredients (g) | IF-01 |
|---|---|
| SARTOMER 506 D | 10.400 |
| EBECRYL 11 | 9.300 |
| EBECRYL 168 | 4.400 |
| EBECRYL 770 | 17.600 |
| SANTICIZER 278 | 6.250 |
| IRGACURE 500 | 2.500 |
| DPGDA | 0.125 |
| PERENOL S | 2.754 |
| Ethylacetate | 1.000 |

### Example 2

### Preparation Layers of Powder LP-01 and LP-02

LP-01 and LP-02 were prepared by uniformly applying the dry powders of Table 2 (thickness approximately 400 μm) on an integrally precured and processed Dupont CYREL HIQ flexographic printing forme.

TABLE 2

| | powder |
|---|---|
| LP-01 | Syloid W300 |
| LP-02 | LX |

### Example 3

### Preparation Layers of Powder LP-03 to LP-06

LP-03 to LP-06 were prepared by (i) mixing the dry powders of Table 3 into ethylacetate (70 wt % ethylacetate, 30 wt % powder), (ii) coating the suspension at a wet coating thickness of 400 μm on an integrally precured and processed Dupont Cyrel HIQ flexographic printing forme (iii) drying the coated layers. The amount of powder after drying is between 130-150 g/m².

TABLE 3

| | powder |
|---|---|
| LP-03 | Syloid W300 |
| LP-04 | Sylysia 450 |
| LP-05 | Sylysia 457 |
| LP-06 | Sylysia 770 |

### Example 4

### Applying the Inkjet Fluid IF-01 on PL-01 to PL-06

Droplets of the inkjet fluid IF-01 were applied on the powder layers PL-01 to PL-06 with a 3 ml plastic pipette.

A UV-A curing of the applied droplets was carried out with a UV-A light box equipped with 8 Philips TL20W/10UVA (λₘₐₓ=370 nm) under nitrogen during 2 minutes. The distance between the lamp and the sample was approximately 10 cm.

A UV-C post curing was carried out with a light box equipped with 4 Philips TUV lamps (λₘₐₓ=254 nm) under nitrogen during 20 minutes.

### Example 5

### Preparation of the Flexographic Printing Formes PF-01 to PF-06

After post curing of the IF-01 droplets applied on PL-01 to PL-06, the powder not being tied together by the cured IF-01 droplets was removed with water.

Printing with the Flexographic Printing Formes PF-01 to PF-06

Printing was carried out on a RK Koater, a laboratory flexographic printing press from RK Print Coat Instruments Ltd, provided with a type 360 anilox roller, having a cell volume of 7.8 cm³/m², and a steel doctor blade. Printing speed was 32.5 m/minute.

The applied ink was Aqua Base Plus Blue ET-51405, a water based pigment flexographic ink from Royal Dutch Printing Ink Factories Van Son. The substrate used was Raflagloss, a glossy art paper from Raflatac Europe.

The prints were evaluated by measuring the density of the printed areas on paper with a Macbeth RD918-SB densitometer. The results are shown in Table 4.

TABLE 4

| | Density on |
|---|---|
| | print |
| PF-01 | 1.78 |
| PF-02 | 1.80 |
| PF-03 | 1.82 |
| PF-04 | 1.60 |
| PF-05 | 1.61 |
| PF-06 | 1.70 |

The results from Table 4 illustrates that with all flexographic printing formes PF-01 to PF-06 good prints are obtained.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-11. (canceled)

12. A method of making a flexographic printing forme comprising the steps of:
providing a flexographic support;
applying a powder layer including a powder on the flexographic support;
imagewise jetting a curable composition on the powder layer;
at least partially curing the imagewise jetted curable composition;
repeating the steps of applying, imagewise jetting, and at least partially curing until a total thickness of the powder layers is greater than 100 μm;
removing the powder not embedded in the imagewise jetted and at least partially cured composition; and
optionally overall post curing.

13. The method according to claim 12, wherein a density of the powder is greater to or equal than a density of the curable composition.

14. The method according to claim 12, wherein the powder consists of inorganic particles.

15. The method according to claim 13, wherein the powder consists of inorganic particles.

16. The method according to claim 12, wherein the powder consists of organic particles.

17. The method according to claim 13, wherein the powder consists of organic particles.

18. The method according to claim 16, wherein the organic particles have elastomeric properties.

19. The method according to claim 16, wherein the organic particles include polymerizable groups at a surface of the organic particles.

20. The method according to claim 18, wherein the organic particles have polymerizable groups at a surface of the organic particles.

21. The method according to claim 12, wherein the curable composition has a viscosity of less than 50 mPa·s at a shear rate of 100 s⁻¹ and at a temperature between 15° C. and 70° C.

22. The method according to claim 12, wherein the step of at least partially curing the imagewise jetted curable composition includes:
partially curing with UV radiation each imagewise jetted curable composition before performing the next step of applying a powder layer.

23. The method according to claim 12, wherein the flexographic support includes one or more at least partially cured layers on a relief forming side of a substrate.

24. The method according to claim 23, wherein the one or more at least partially cured layers are formed by:
applying to the substrate a powder layer;
jetting a layer of a curable composition on the powder layer;
at least partially curing the jetted curable composition; and
optionally repeating the steps of applying, jetting, and at least partially curing.

25. A method of flexographic printing comprising the steps of:
providing a flexographic printing forme obtained according to claim 12 on a flexographic printing press;
applying ink to the flexographic printing forme; and
transferring the applied ink to a substrate.
